(19) United States
(12) Patent Application Publication
(10) Pub. No.: US 2012/0173881 A1
(43) Pub. Date: Jul. 5, 2012

(54) Method & Apparatus for Remote Information Capture, Storage, and Retrieval

(75) Inventors: Frederick Trotter, Houston, TX (US); Carolyn Oliver, Houston, TX (US); Leonard Hoffman, Houston, TX (US)

(73) Assignee: Patient Always First, Houston, TX (US)

(21) Appl. No.: 12/983,730

(22) Filed: Jan. 3, 2011

(51) Int. Cl. G06F 12/14

(52) U.S. Cl. 713/189

(57) ABSTRACT

The present disclosure relates to methods and systems that restrict access to stored sensitive information. Specifically, the methods and systems of the present disclosure separate the management of access to data from the encryption and storage of the data itself. The present disclosure allows for retrieval of the access without providing such access to the data host. Further, the present disclosure provides for data ownership privileges that can grant or revoke access. The present disclosure further provides for audio-access of stored data.

### FIELD OF INVENTION

The present invention generally relates to information capture, storage, and retrieval, and more particularly to controlling access to stored information.

### BACKGROUND

A data encryption system can be an effective technique for controlling access to sensitive data. Known encryption systems often employ algorithms seeded with an encryption key. Encrypted data is difficult to decipher or decrypt without knowledge of the key used for encryption or a related key. Accordingly, safe management of the key is an important aspect to ensure only authorized users can access the sensitive information.

Unfortunately, known encryption systems are susceptible to flawed key management techniques, thereby limiting the effectiveness of the encryption system. For example, one key management technique may rely on human users to create and provide keys. Encryption systems that rely on user-provided keys may be susceptible to insecure or low quality keys, forgotten keys, stolen keys, or key sharing. Low quality keys may allow encrypted data to be susceptible to deciphering analysis techniques. Forgotten keys may lead to data that is permanently encrypted, and effectively lost. Key sharing between users or a stolen key may allow an unauthorized user access to encrypted data. That is, anyone with access to the encryption key can have access to private data, meaning once a key is shared, there is no effective way of restricting further sharing of that key. Moreover, providing users direct knowledge of encryption keys may limit the ability to use an encryption system for authorizing access to encrypted data.

Moreover, providing high quality keys, i.e., making it more difficult to decipher encryption without a key, does not address the problem of privacy, i.e., key sharing or restricting access to the key itself. For instance, asymmetric encryption provides highly secured encryption where the key used to encrypt the sensitive data is not the same as the key used to decrypt it. This type of encryption is achieved through the use of a pair of cryptographic keys: a public encryption key and a private decryption key. The data is encrypted with the public key and can only be decrypted with the corresponding private key. The keys are related mathematically, but the private key cannot feasibly be derived from the public key. As such, asymmetric encryption provides more security and privacy than symmetric encryption, where the same key is used for both encryption and decryption, by not giving the encryptor access to the private key by default. Asymmetric encryption, however, does not address the problem of restricting access to the private key because anyone who has the private key, obtained with or without permission, can retrieve the decrypted sensitive data. For instance, a data hosting site can encrypt stored data asymmetrically to restrict access to only authorized users with the private key. Practically speaking, the data host must also have a copy of the private key. Otherwise, if the host does not have the private key, but instead relies on a user to maintain the private key, and the only copy of the private key is lost, the data is effectively lost permanently because the data cannot be decrypted without the private key. Because the host also has a copy of the private key, there are no effective safeguards against rouge host administrators. Instead, the user must rely on the host's own enforcement of its privacy policy. This requirement forces typical system designers to make a difficult choice between either trusting users to maintain their own keys, ensuring that only those users have access to their own data (perfect privacy) or holding the keys for the user, ensuring that the user's privacy is in the hands of potentially untrustworthy system administrators (the insider threat).

Other complex systems, like Kerberous (which forms the basis of Microsoft's network security protocols) and web-based security architectures like Shibolleth and SAML provide user managed private keys. Nevertheless, these systems still have some “password recovery” functionality that allows administrators to emulate users and ultimately present the possibility that an administrator will violate a user's privacy. As such, these systems still require the system designers to make a choice between placing the only copy of the private key with the user or trusting system administrators. While many systems have mechanisms in place to ensure that administrator abuse is difficult (logging, etc.), there are few mechanisms available to provide practical separation of powers (ability to access user keys vs. the ability to access encrypted user data) and none available that work with the fundamental log-in capabilities practically available in the World Wide Web (HTML/HTTP) environment.

In addition to stored data that may be retrieved remotely through the Internet or other similar means, known systems do not provide for similarly restricted access to stored audio information that can be retrieved over the phone by a user. Instead, audio data stored with a data host is often symmetrically encrypted with the user's phone itself. This allows the data host to provide access to encrypted data over the phone when the system authenticates the phone number of the user's phone, such as by caller ID. If, however, the user's phone number is stored in plain text in the system and directly associated with the user's account, then the user's security and privacy to the sensitive information are potentially compromised, particularly in situations involving untrustworthy system administrators. Because a common and simple way to identify a particular user calling into a phone-based information system is via the user's phone numbers, it is difficult to provide complete privacy to audio data that can potentially be created using phone calls, where the association between the user account and a particular call is merely a caller ID based phone number.

In view of the above, there is still a need for a system that provides desired restricted access to the private key for retrieval of stored sensitive information without sacrificing the convenience of having the capability of retrieving the private key when it is forgotten or lost.

### SUMMARY OF THE INVENTION

One objective of certain embodiments of the present invention is to provide methods and systems to restrict access to stored sensitive information.

Another objective of certain embodiments of the present invention is to provide methods and systems for selective sharing of sensitive information.

Yet another objective of certain embodiments of the present invention is to provide access to stored sensitive audio data.

To meet these objectives, there is provided a method for managing data access comprising the steps of: encrypting data for a user with a public key of the user; storing the encrypted data; encrypting a private key with an identifier associated with the user, the private key is configured to decrypt the encrypted data; storing the encrypted private key; and deleting the private key subsequent to said step of encrypting the private key.

There is provided another method for managing data access comprising the steps of: encrypting data for a first user with a file key; encrypting the file key with a public key of the first user; storing the encrypted data for the first user; encrypting a private key with an identifier associated with the first user, said private key configured to decrypt the encrypted file key; storing the encrypted private key; and deleting the private key subsequent to said step of encrypting the private key.

In some embodiments, the method further includes the step of providing a second encrypted file key to a second user, the encrypted second file key generated by encryption of said file key with the second user's public key

In other embodiments, the second encrypted file key is configured to be deleted by the first user. In some embodiments, a first portion of said encrypted data is encrypted with a first file key.

In other embodiments, the identifier comprises the user's phone number, and in some embodiments, the identifier comprises said user's directed identity.

In another aspect of the invention, there is provided a system for managing data access comprising encrypted data for a first user, the data is encrypted with a file key; a first encrypted file key generated by encryption of the file key with a public key of the first user; and an encrypted private key for the first user, the private key encrypted with an identifier associated with the first user, where the system does not store the private key.

The foregoing has outlined broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily used as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 illustrates a diagram of one embodiment for managing data access using a provided identifier according to one aspect of the present invention.

FIG. 2 illustrates a diagram of another embodiment for managing data access using a provided identifier according to one aspect of the present invention.

FIG. 3 illustrates a diagram of an embodiment for sharing data access using different identifiers according to one aspect of the invention.

FIG. 4 illustrates a diagram of yet another embodiment for managing access to audio data and other data using a provided identifier according to one aspect of the present invention.

FIG. 5 illustrates a diagram of an embodiment for sharing access to audio data and other data using different identifiers according to one aspect of the present invention

It should be understood, of course, that the invention is not limited to the particular embodiments illustrated herein. In certain instances, details that are not necessary for an understanding of the disclosed methods and apparatuses or that render other details difficult to perceive may have been omitted.

### DETAILED DESCRIPTION

The present disclosure provides the desired restricted access to the private key for decrypting sensitive information without sacrificing the convenience of retrieving access to the private key should it ever be lost. In a preferred embodiment, this result is achieved by separating the private key access management from the storage and encryption of the data. In one exemplary embodiment, a directed identity, typically implemented using OpenID, is used to symmetrically encrypt the user's private key that is used to decrypt and retrieve sensitive information. This sensitive information is stored with a data host, and it may be asymmetrically encrypted with the user's public key. As such, the directed identity provider provides the private key access management by giving the user a password and password reset functionality, including changing of the password over time. Correspondingly, it is no longer necessary for the data host to maintain and store a copy of the private key because the possibility of a lost key has been eliminated. As described, neither the data host nor the directed identity provider can violate the privacy of its users without collusion because the data host does not have the private key and the directed identity provider does not have the encrypted data.

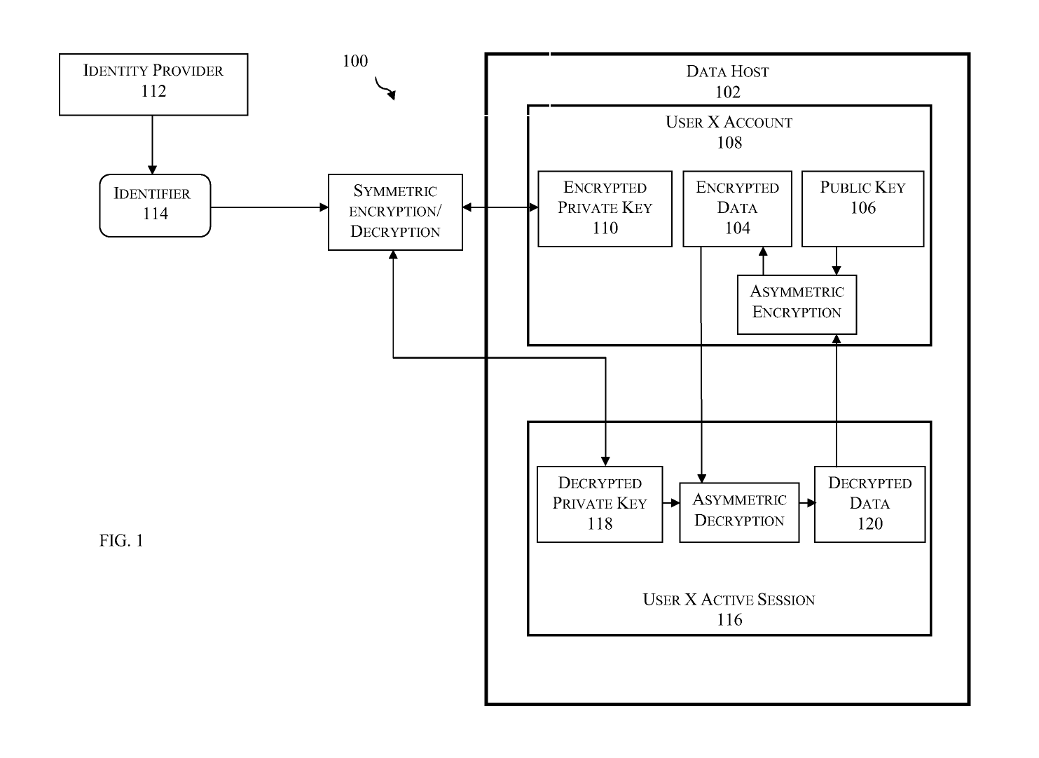

Referring now to FIG. 1, system 100 includes a data host 102 that stores encrypted sensitive information 104 from user X. The sensitive information 104 has been encrypted with user X's public key 106. As such, the sensitive information 104 can only be decrypted with user X's private key 110, which is in turn encrypted with user X's directed identity provided by a trusted identity provider 112. The data host 102 may store a copy of user X's encrypted private key 110, a copy of user X's public key 106, and user X's encrypted information 104 together under user X's account 108. Accordingly, the data host 102 may employ any OpenID protocol that enables trusted third parties to act as identity providers, and preferably, any OpenID provider who supports the directed identity feature of the OpenID protocol can be used. As known in the art, directed identity is the concept of having a single identity that appears to be a different identity for every relying party (i.e., an application that wants to verify a user's identity). That is, for directed identity, a unique and secret OpenID identifier is consistently provided to each relying party, e.g., a data host, to authenticate the identity of the user that just verified his or her identity with the identity provider, e.g., by logging into the provider's website.

A directed identity can be provided by a login from the Open ID protocol. Open ID providers do not always support directed identity. However, any non-directed identity Open ID provider can be made to support directed identity using well-understood capabilities of the Open ID protocol, such as using a directed identity proxy. That is, because the Open ID authentication and login method can be proxied, it is possible for any Open ID provider to serve as the ultimate source of a directed identity by using a directed identity proxy. This functionality is described by http://willnorris.com/2009/08/a-new-kind-of-openid-proxy. More importantly, Google, one of the world's largest Open ID based identity providers, supports directed identity by default. This means that Google currently supports the secure identity provider role, and other very large Open ID user bases such as Microsoft, Yahoo, AOL, and Facebook can be made to support the secure identity role of directed identity. Practically, this means that the vast majority of users who regularly use the Internet already have access to a user account that could serve as the “key source” for this encryption scheme. As a result, the implementers of this method need only implement the data provider portion of the process.

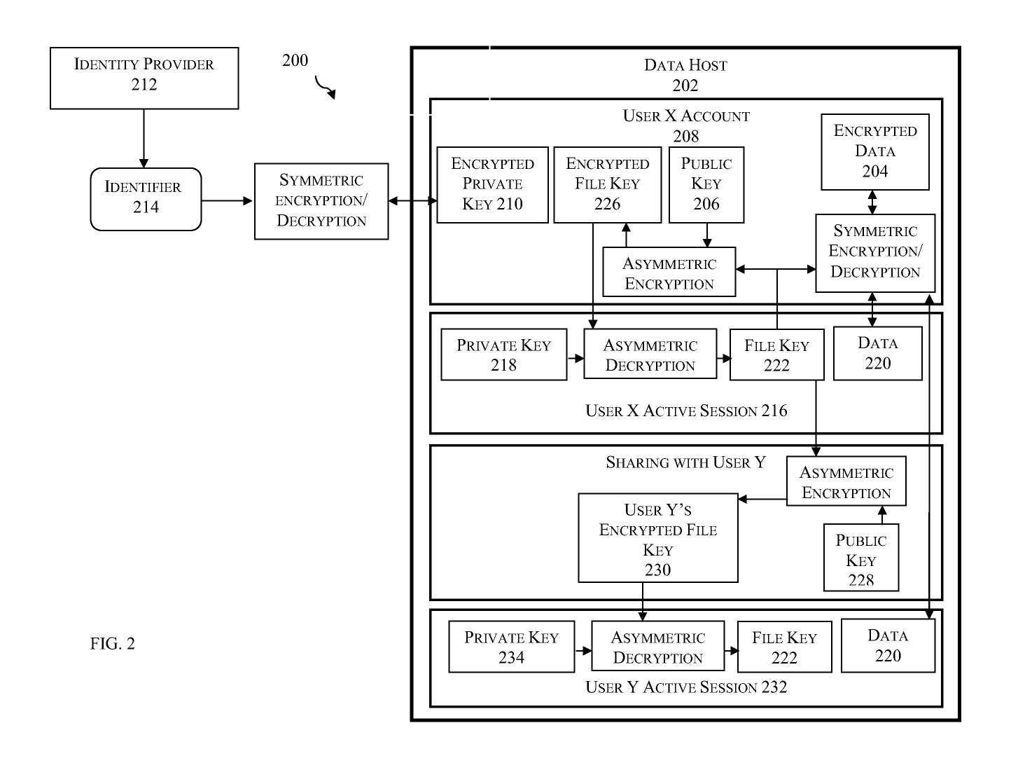

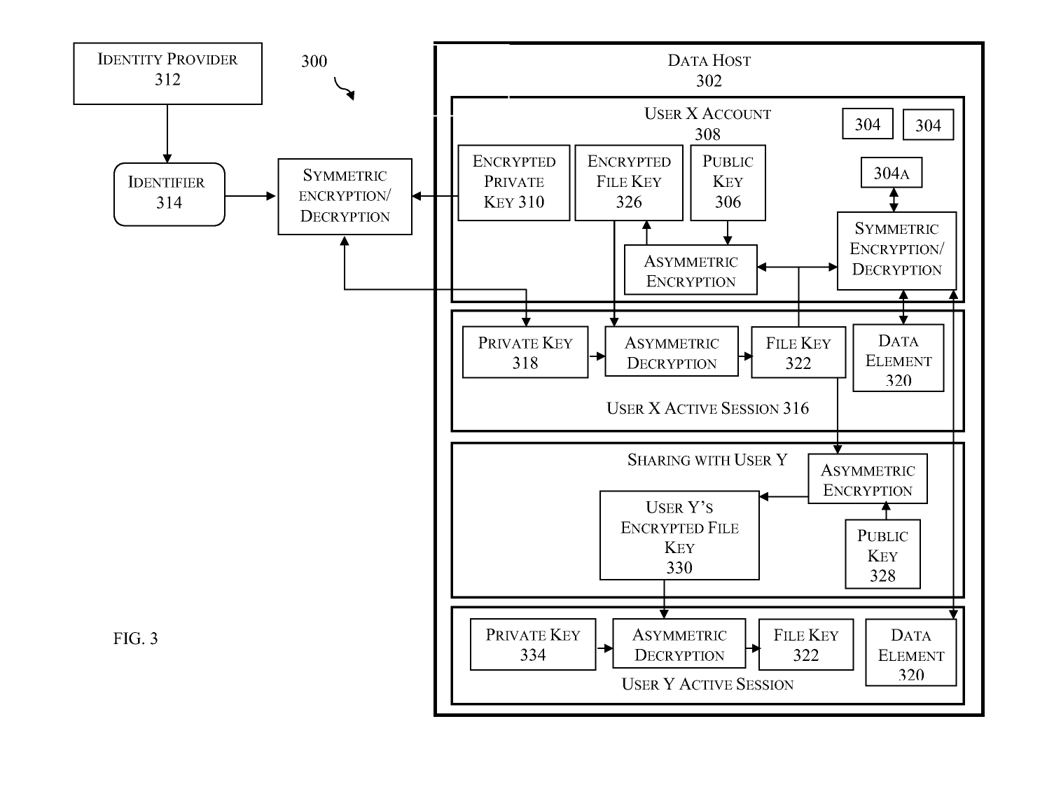

Referring to FIG. 1, after the user successfully confirms the correct identity, the identity provider 104 sends a unique directed identifier 114 to data host 102 that identifies the user to the data host 102 so the data host 102 can match the directed identifier with its record and provide access to information stored for that user. For instance, the data host 102 can initiate a new session 116 for user X upon authentication. During this session, the directed identity 114 can be used to decrypt the encrypted private key 110, giving user X a decrypted private key 118. With a decrypted private key 118, user X can now decrypt the encrypted sensitive data 104 stored with the data host 102 and retrieve usable information 120 in session 114. Alternative embodiments are discussed below with respect to FIGS. 2 and 3. Directed identifiers for OpenID have been used for authentication purposes only and have not heretofore been employed in encryption applications that enable the management of access to the private key to be separate from the encryption and storage of the sensitive information.

As described above, only the user X has access to his or her own unencrypted data 120. Neither of the two trusted parties, data host 102 and identity provider 112, can violate the user's privacy without violating corporate policies or the law. For instance, the identity provider cannot obtain the decrypted information without committing fraud, e.g., intentionally deceiving the data host info believing that it is in fact the user. Further, the present disclosure provides additional security because any third party would need to gain access to resources at both of the trusted parties to violate the user's privacy.

For instance, the system can be designed to perform auto auditing so that the trusted parties, data host 102 and identity provider 112, comply with privacy requirements. This OpenID-oriented software design directly forbids data hosts from caching the directed identifiers on its system. One potential problem, however, is that data hosts could potentially circumvent the system design by modifying the system source code to perform such caching. One way of preventing the circumvention is to integrate a semi-automated source code audit system into the data host. This integration can be achieved by requiring the source code to be published so that the public can verify that the source code does not cache the directed identity provided by the identity provider that allows for decryption of the private key. Alternatively, a trusted third party may be employed to periodically verify that the source code does not cache the directed identifiers. This addition makes the already-difficult-to-abuse method of changing the running code on a data host into something even more unlikely.

Further, to confirm that the complying source code has not changed over time, either a third party service or a downloadable toolkit, such as a public source code download, can be established to provide cryptographic hashing against the confirmed source code to verify that it does not change over time. In certain embodiments, the system is capable of accepting arbitrary salt strings so that hash results can be unique on a per run basis. Further, the system may allow testing of the entire source code file or just a subset. (In cryptography, “salt” consists of random data used as one of the inputs to a key derivation function, and a cryptographic hash function is a deterministic function that takes any block of data and returns a hopefully unique string that consistently changes when the block of data changes.) Preferably, the data host provides this service to allow any user to verify that the data host is running a version of the software that is identical to the software tested or verified by the trusted third party. In a preferred embodiment, configuration information must be loaded in as data files (XML, TXT, YAML, or the like) so that the configuration file source code can also be tracked in this manner. In some embodiments, configuration data, which must change on a per data host basis, can be fully excluded from the process. This ensures that only pragmatically active portions of a data host can be tracked. Other static data files, such as privacy policy, end user agreements, and software licensing files can also be tracked in this way.

Preferably, frequent and irregular third party audits should be performed to provide real-time assurance that the source code has not been modified. Frequent auditing would prevent a rouge data host from circumventing the system by pointing the hash process to a clean copy of the source code files and then running the real-time hash process against that clean copy. For instance, on an irregular basis, data hosts may be audited by trusted third parties who may certify that the data hosts have not gone rouge. The semi-auto auditing process described above addresses at least two threats to the privacy and security of stored sensitive information: (1) rouge insiders at a data host, e.g., employees of data hosts stealing the stored sensitive information and (2) rouge data hosts.

The present disclosure prevents rogue insiders from stealing the stored sensitive data because, unlike prior art systems, the rogue insiders do not have access to the private key outside of collusion with the identity providers. With respect to rouge data hosts, most data host's privacy policies include clauses that essentially give the data host the right to change the privacy policy at any time. Consequently, it is possible for data host owners to rewrite the privacy policy to allow them to sell what had previously been private. In such circumstances, the third party auditor can notify the users that a data host had gone rouge.

The present disclosure also allows for sharing, particularly selective sharing, of the sensitive information without releasing access to the private key. Referring to FIG. 2, system 200 includes a data host 202 that stores encrypted sensitive information 204 from user X, which has been symmetrically encrypted with a file key 222, which may be a randomly generated password. This file key 222 is in turn asymmetrically encrypted with user X's public key 206. Accordingly, file key 222 can only be decrypted with user X's private key 218, which has been encrypted with user X's directed identity 214 provided by a trusted identity provider 212. The data host 202 may store an encrypted private key 210, an encrypted file key 222, the public key 206, and the encrypted data 204 together under user X's account 208. In user X's active session 216, the directed identifier 214 is used to obtain decrypted private key 218 through symmetric decryption, which in turn is used to obtain decrypted file key 226 through asymmetric decryption, which in turn is used to obtain decrypted data 220 through symmetric decryption. As described, system 200 provides an alternative embodiment to system 100 described with respect to FIG. 1, where sensitive data 104 is asymmetrically encrypted with user X's private key 110.

Also, the sensitive data 204 may be shared with other individuals without sharing access to user X's private key 210 by asymmetrically encrypting the file key 226 with user Y's public key 228 to create user Y's encrypted file key 230, where user Y is an individual with whom user X wishes to share the sensitive data 204. Consequently, user Y may access sensitive data 204 in user Y active session 232 by using user Y's private key 234 to decrypt file key 230 and obtain file key 226, which allows for decryption and access to user X's sensitive data 220. In a preferred embodiment, user Y's private key is also encrypted with user Y's directed identifier provided by identity provider 212 or another identity provider. The owning user, user X, can delete this access by removing the record previously created. That is, by deleting user Y's encrypted file key 220 or any other encrypted file keys created for sharing purposes, user X has eliminated that user's access to user X's own private information. Consequently, the present disclosure may define data ownership as having the privilege to manage, i.e., grant and revoke, access to any given data by other users. For example, the present disclosure provides a “take back” option that is not available in other systems where once access to the sensitive information is granted, e.g., sharing of the private key, it cannot be revoked or restricted. For instance, user Y informs user X that user Y has accidentally lost his own private key 218 or that key has been stolen, user X's data is not compromised because user X can delete encrypted file key 220 and create a new file key for user Y.

Moreover, user X may also selectively share a portion of the sensitive data stored on the host data. Referring to FIG. 3, user X's sensitive data may be divided into separate data elements 304 stored by the data host 302. Similar to FIG. 2, FIG. 3 shows a data host 302 storing the encrypted data elements 304 from user X. If user X wishes to share a specific data element 304A with user Y, then user X can symmetrically encrypt only data element 304A with a file key 322, which may be a randomly generated password or the result of a symmetric encryption algorithms. User X may leave the remaining data elements 304 as they are or encrypt them with another file key. This file key 322 is in turn asymmetrically encrypted with user X's public key 306. Accordingly, access to certain data elements 304 can be established and maintained because a user can access the particular data elements if and only if the symmetric file key 322, or other respective symmetric keys, has been encrypted with that user's public key. As described above, the present disclosure allows for sharing of current items, and any items created and stored in the future will not be automatically shared with other users having some authorized access. Instead, the data owner, user X, has the privilege to grant access to any future items as he or she sees fit.

Likewise, it is possible for a data owner to provide access to a computer program or service that modifies encrypted data elements stored at a data host. Preferably, in providing such access, web service API tokens are used to provide third party applications access to user data. For instance, if user X chooses a third party service that requires certain data elements, e.g., 304 of FIG. 3, the user can share access with that service by encrypting the symmetric key(s), e.g., file key 314, of protected data elements with the public key for that service. Essentially, using tokens, a user can provide a directed identity mechanism that is not practically dependent on the Open ID protocol to some third-party program (third party in the sense that they are neither the original directed identity provider, nor the data host). A user can share with a software service in the same cryptographic manner in which he can share with another user on the system. But unlike another user, the program uses a directed identity token(s) provided explicitly by the user. This is not uncommon from other token-based web-service API designs, except that it integrates seamlessly into an asymmetric user sharing mechanism.

The present disclosure is particularly applicable in voice applications, allowing a user to access sensitive audio information stored with a data host over the phone. As mentioned above, in most systems allowing such access, the audio data is often symmetrically encrypted with the user's phone number. This set-up allows the data host to provide access to encrypted data over the phone when the system authenticates the phone number of the user's phone, such as by caller ID. This type of encryption, however, does not provide sufficient security and privacy to the sensitive information and exposes the user's phone number if it is stored in plain text and directly associated with the user's account. If the phone number is used as the symmetric encryption key for the user's private key, then a rouge administrator can use the phone number in the database to access the private key, negating the benefit of the fundamental design. Unchecked, this problem would prevent any phone generated audio data from being secured in the described manner.

The present disclosure addresses this problem in several ways. For instance, in some embodiments, the phone record can be strongly associated with a user using a cryptographic hash of the phone number, and the phone number itself would not need to be stored in plaintext. Instead, the phone number can be stored in a cryptographic hash, where the hash can be used to perform a database lookup to find a copy of the encrypted private key that can be decrypted with the plaintext phone number. Essentially this aspect of the present disclosure integrates a non-directed identity to identity proxy directly embedded at the data host. This method allows a phone call with caller ID to emulate a directed identity mechanism in parallel with Open ID and API tokens.

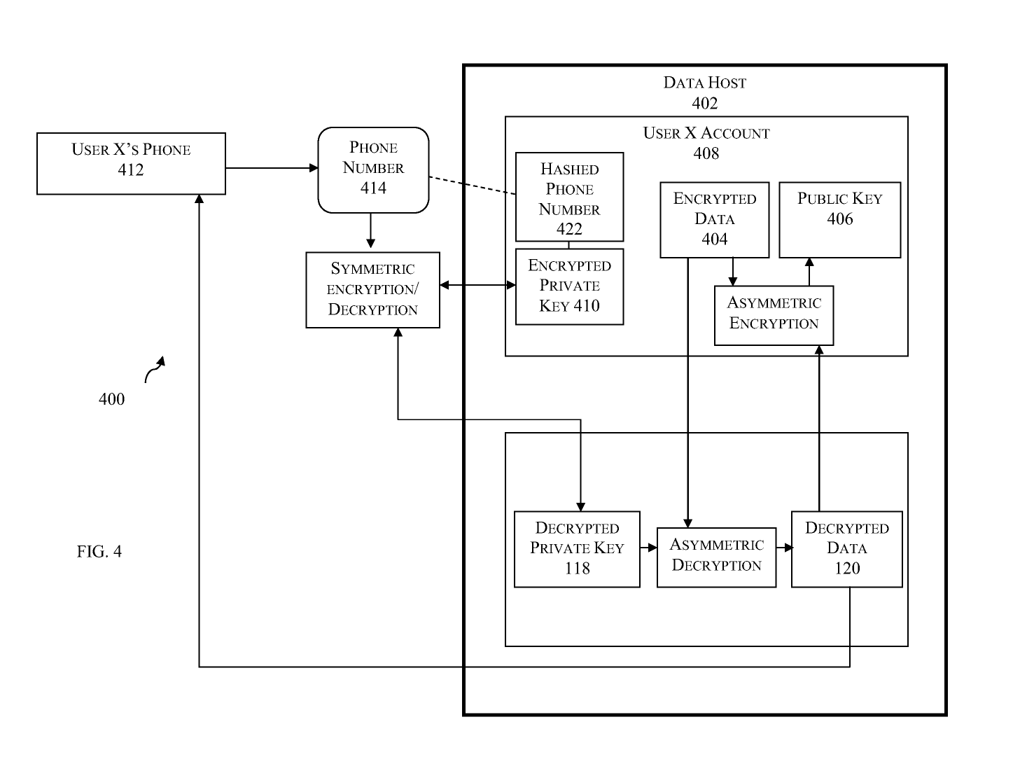

Referring to FIG. 4, data host 402 stores and associates a cryptographic hash copy 422 of user X's phone number 414 with user X's account 408 and/or user X's private key 410. User X's account 408 may store encrypted sensitive data 404. Preferably, the sensitive information has been asymmetrically encrypted with user X's public key 406. Upon matching user X with the respective account, system 400 may retrieve user X's private key 410, which has been encrypted with user X's phone number 414. User X may then enter his or her phone number to symmetrically decrypt the private key, thereby decrypting and gaining access to the sensitive information 404. That is, user X's phone number serves a similar purpose as the directed identity of system 100.

It is understood that a system similar to systems 200 or 300 may be implemented for audio access and sharing. For instance, instead of being encrypted with user X's public key, the sensitive information may be symmetrically encrypted with a file key, which is in turn encrypted with user X's public key. A different file key may be created for different phone numbers to allow other users or the same user using a different phone to access the sensitive information. This ensures that a calling end user can get access to the private key and therefore decrypt the protected data but rouge employees cannot obtain such access. Accordingly, it is not necessary for the data hosts of the present disclosure to store the user's phone numbers, which maintains the privacy of the users' phone numbers.

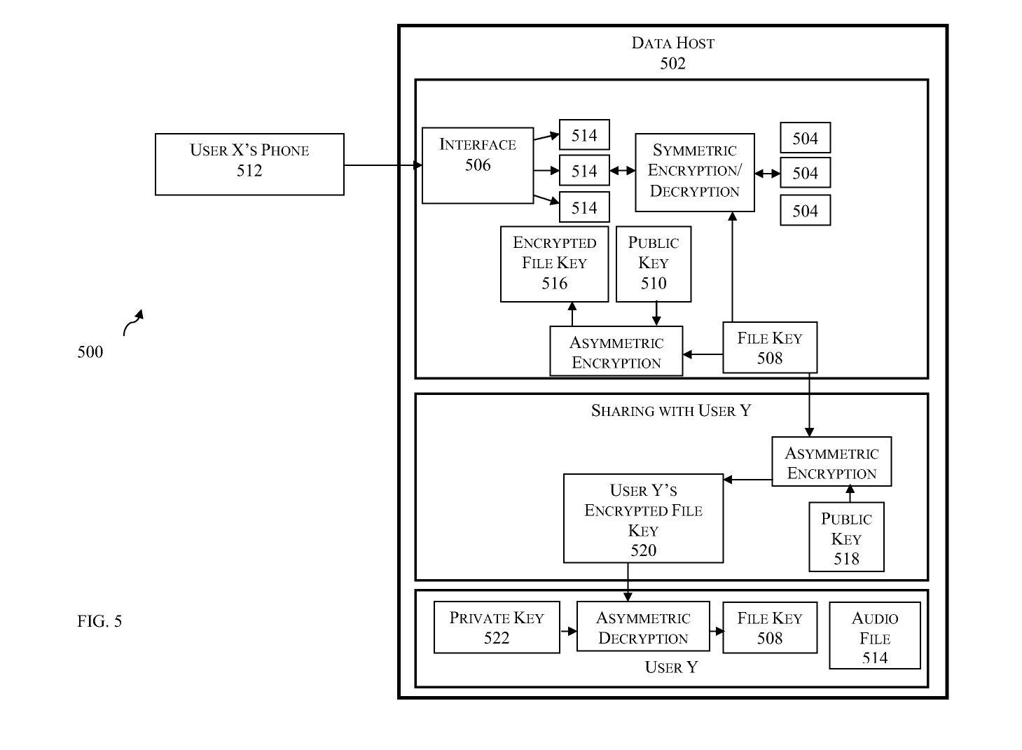

Moreover, the present disclosure provides for decrypting and streaming of encrypted audio files or other types of data. Referring to FIG. 5, preferably, system 500 includes a data host 502 that may employ an interface 506 that uses specific caller ID information to automatically create a set of data elements 514 that only the owner of the phone with that specific caller ID information can access. For instance, a single data element 514 may be created each time a call associated with user X's phone number, determined by caller ID or other similar means, is placed with data host 502. The owner of that phone, user X, can login to the website of the data host 502 to authenticate ownership of the particular phone, cellular or otherwise. Authentication can be achieved by accepting a single text message or phone call to that phone number. Once authenticated, the phone owner, user X, may share and comment on the recording through a web interface provided by the host data according to the present disclosure. Preferably, the data host 502 generates a separate unique URL for each encrypted audio file 504. That way, a user can easily share the URL without fear that the audio content is accessible without the user's authorization. The URL will not work for any user that does not have the appropriate keys.

Referring to FIG. 5, in one embodiment, sharing can be achieved by symmetrically encrypting an audio file 504 with a file key 508. That file key 508 is in turn asymmetrically encrypted with user X's public key 510 to create encrypted file key 516 and/or another user's public key for sharing purposes according to the above disclosures. That is, file key 508 may be encrypted with the public key 518 of another user to generate encrypted file key 520, thereby restricting access to audio file 504 to only those users whose public keys have been used to encrypt file key 508, e.g., user Y with private key 522.

This functionally allows for an end user to share audio streams or other data while limiting access to the shared audio files or other data to the trusted individuals. If a user who was not trusted by the data owner tried to access the URL they could be directed to a page that would allow them to request access from the owner. Even the site administrator can be prevented from accessing the data, such as audio or video content. Further, the present disclosure allows for sharing of individual recordings one at a time. Moreover, the present invention provides for a “locking” feature where a user can prevent any accidental access of recordings or other data that are embarrassing or not meant to be shared. For example, a “locked” recording will be ignored by the system if a “share all recordings/data” option is selected, or a “locked” flag will remove any sharing authorizations, e.g., file keys encrypted with another user's public key, that currently exists for a given recording.

The present disclosure may also apply to facilitate secured sharing of information in existing Public Key Infrastructure (“PKI”) environments. In cryptography, a PKI is an arrangement that binds public keys of users with their respective user identities by means of a certificate authority (CA). For each user, the user identity, the public key, their binding, validity conditions, and other attributes are made unforgettable in public key certificates issued by the CA. Consequently, user X may share any sensitive information with another user in a PKI environment by encrypting the file key with the sharing party's public key. Further, the present disclosure may be particularly applicable to the medical field to allow physicians access to play back certain audio recordings.

In particular, users can share specific recordings or other data with doctors using the Nationwide Health Information Network (NW-HIN) Direct SMTP (Simple Mail Transfer Protocol) and certificate infrastructure. The NW-HIN is a set of protocols that enables a secure health information exchange to occur over the open Internet. This encrypted network relies on a PKI infrastructure based on standard X.509 PKI, which is compatible with typical PKI implementations of this method. As a result, a user can encrypt a combined token plus URL that, when merged, would provide unfettered access to a recording or other data. By encrypting the unique URL to a recording or other data, which is preferably generated as described above with respect to FIG. 5, into a NW-HIN direct message using the doctor-of-interest's public key, a user can share any health record, including recordings, with any NW-HIN doctor in the United States. Current Health IT regulation ensures that the NW-HIN will become the de-facto health information exchange in the United States, and probably later internationally. Eventually most clinicians will be accessible over this new network, making this cryptographic design fundamentally compatible with controlled sharing across the network. Because the security design of the present disclosure uses PKI for access control and remotely hosted URLs for data, it will allow the ability to revoke any access that has been previously granted across the NW-HIN or other similar secure networks based on PKI technology for access control.

The present disclosure also provides for denoting doctors having certain specialties in the system. If a given doctor wants to be marked as a specialized doctor, that doctor can be authenticated as being certified in or a specialist in that field, e.g., using PKI certificate associated credentials. For example, authentication can be achieved by completing a fax based authentication based on the fax number provided by the specialist's NPI (National Provider ID) database record. Once authenticated, the information can be shared within the system, based on both specific doctor identity or on specific specialization. In certain embodiments, doctors without a verified doctor account can be invited to the system by their patients or other doctors. Preferably, the invitation may be sent via fax by the system to the doctor's NPI record. Once authenticated, the doctors may be able to create audio recordings or other data for a given patient (after that patient has given them access to his or her records). The doctors may create the audio or video recordings with a flash-style web record device provided by the data host interface, e.g., browser, or they can use another recording method and upload the corresponding audio or video file. Other data types can be created using similarly standard mechanisms and seamlessly integrated into the doctor/patient system according to the aspects of the present disclosure described herein. In other embodiments, when the doctors are creating or uploading the audio file, the name and picture of the respective patient will be displayed to ensure that the doctors do not send the recording to the wrong patient.

Access control to specific patient data, or other general data in the system can be given to doctors in more or less arbitrary grouping based on data available in the NPI record. For example, access can be provided to arbitrary groups of doctors (i.e., a specific given patient's care team), doctors associated with a given doctor, doctors who share a common specialty or group of specialties, doctors who share an address, or even distance based on geo-location calculations. The richness of the NPI record and the fundamental capabilities of PKI ensure that access within the data host can easily be set using publicly available information about doctors or other clinicians inside the NPI database. Moreover, because OpenID is a transitive authentication protocol (allows proxying) these access control and authentication mechanisms can easily be forwarded to other data hosts. Similarly, these access control and authentication mechanisms can be exposed independently to any other data host directly via a Web Service API.

Further, in other embodiments, doctors can also record messages for a given patient by simply clicking a button on a web interface. Once the button is clicked under a given patient name or photo, that doctor will receive a call to their cell phone or other handheld devices that will allow them to record a message for the given user. Alternatively, this button can be replaced by a special URL, which allows the doctor to print a QR code or other graphical URL coding system for a given patient and then affix a QR code onto a given chart. This coding allows the doctor to use handheld devices, such as a camera phone, to read the code and receive the automated phone call for the correct patient. For instance, other devices, including any device that has either a digital camera, or bar coding capacity, as well as the ability to browse the world-wide-web, can be used as a mechanism to initiate these calls. In one embodiment, the resulting data would be an audio file, but a digital phone menu could be used to ask any series of questions, enabling simple data collection using this mechanism. Generally, any notion of audio data mentioned in any embodiment can be similarly extended to encompass other data formats. This functionality allows for either the doctor or the patient to initiate a call into the server that will deposit the audio file into the correct account.

Although the present invention and its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be used according to the present invention. Accordingly, the appended claims are intended to include within their scope such processes, machines, manufacture, compositions of matter, means, methods, or steps.

1. A method for managing data access comprising the steps of:
encrypting data for a user with a public key of said user;
storing said encrypted data;
encrypting a private key with an identifier associated with said user, said private key configured to decrypt said encrypted data;
storing said encrypted private key; and
deleting said private key subsequent to said step of encrypting said private key.

2. A method for managing data access comprising the steps of:
encrypting data for a first user with a file key;
encrypting said file key with a public key of said first user;
storing said encrypted data for said first user;
encrypting a private key with an identifier associated with said first user, said private key configured to decrypt said encrypted file key;
storing said encrypted private key; and
deleting said private key subsequent to said step of encrypting said private key.

3. The method of claim 2 further comprising the step of:
providing a second encrypted file key to a second user by encrypting said file key with a public key of said second user.

4. The method of claim 3, wherein said second encrypted file key may be deleted by said first user.

5. The method of claim 3 wherein a first portion of said encrypted data is encrypted with said file key.

6. The method of claim 1 wherein said identifier comprises said user's phone number.

7. The method of claim 1 wherein said identifier comprises said user's directed identity.

8. The method of claim 2 wherein said identifier comprises said first user's phone number.

9. The method of claim 2 wherein said identifier comprises said first user's directed identity.

10. The method of claim 1 wherein a portion of said encrypted data comprises audio data.

11. The method of claim 2 wherein a portion said encrypted data comprises audio data.

12. The method of claim 5 further comprising the step of:
creating a URL for at least said first portion of said encrypted data.

13. A system for managing data access comprising:
encrypted data for a first user, said data encrypted with a file key;
a first encrypted file key generated by encryption of said file key with a public key of said first user; and
an encrypted private key for said first user, said private key encrypted with an identifier associated with said first user,
wherein said system does not store said private key.

14. The system of claim 13 further comprising:
a second encrypted file key for a second user, said encrypted second file key generated by encryption of said file key with said second user's public key.

15. The system of claim 14 wherein said second encrypted file key may be deleted by said first user.

16. The system of claim 14 wherein a first portion of said encrypted data is encrypted with said file key.

17. The system of claim 13 wherein said identifier comprises said first user's phone number.

18. The system of claim 13 wherein said identifier comprises said first user's directed identity.

19. The system of claim 13 wherein a portion of said encrypted data comprises audio data.

20. The system of claim 16 further comprising:
a URL for at least said first portion of said encrypted data.
